(19) United States
(12) Patent Application Publication
(10) Pub. No.: US 2023/0014415 A1
(43) Pub. Date: Jan. 19, 2023

(54) REDUCING TRANSACTIONS DROP IN REMOTE DIRECT MEMORY ACCESS SYSTEM

(71) Applicant: HUAWEI TECHNOLOGIES CO., LTD., Shenzhen, Guangdong (CN)

(72) Inventors: Ben-Shahar BELKAR, Hod Hasharon (IL); Dima RUINSKIY, Hod Hasharon (IL); Lior KHERMOSH, Hod Hasharon (IL)

(21) Appl. No.: 17/947,826

(22) Filed: Sep. 19, 2022

Related U.S. Application Data
(63) Continuation of application No. PCT/EP2020/074751, filed on Sep. 4, 2020.

(51) Int. Cl. G06F 12/1081; G06F 12/0862

(52) U.S. Cl. CPC G06F 12/1081; G06F 12/0862

(57) ABSTRACT

In order to reduce remote direct memory access (RDMA) requests drop in RDMA systems, a requesting device transmits a message that includes a prefetch operation to a responding device. The prefetch operation indicates a memory area to be loaded by the responding device to a memory of the responding device before receiving a new RDMA request or a RDMA command.

### CROSS-REFERENCE TO RELATED APPLICATIONS

This application is a continuation of International Application No. PCT/EP2020/074751, filed on Sep. 4, 2020. The disclosure of which is hereby incorporated by reference in its entirety.

### TECHNICAL FIELD

The present disclosure relates generally to the field of data communication and remote direct memory access (RDMA) systems; and more specifically, to requesting devices, responding devices, and methods for reducing transactions drop in a remote direct memory access system.

### BACKGROUND

Data communication at a high speed among multiple computing devices in a network, raises concern about data communication reliability and efficiency. Traditionally, a conventional remote direct memory access (RDMA) technique (or protocol) is employed in which a hardware device such as a conventional requesting device (or a client) directly accesses a memory of a conventional responding device (or a server). The conventional RDMA technique requires a virtual memory (that is a portion of the memory of the conventional responding device) used for any RDMA transaction (e.g. a local and a remote RDMA transaction) to be pinned (means always present in physical random access memory (RAM)) at the time the conventional requesting device attempts a direct memory access (DMA) request (e.g. a RDMA read or a RDMA write request). Therefore, in the conventional RDMA technique, a general approach such as a memory pinning is used for making sure that the conventional requesting device accessing the memory (e.g. the physical memory) directly does not have to deal with mapping of pages which can be changed by other entities (e.g. a typical operating system (OS)) or being swapped out entirely. The memory pinning is a technique used by the typical operating systems to prevent a memory subsystem from moving physical pages from one location to another, and possibly alter a virtual address (VA)-to-a physical address (PA) translation. The memory pinning also prevents memory pages of the memory subsystem moving from random access memory (RAM) into a backing store or a swap area (a process known as “swapping out”). For example, in a case, the pinned memory (i.e. the virtual memory or the memory subsystem cannot be swapped out or reclaimed by the typical operating system) is used by the conventional requesting device for direct memory access (DMA) because most of the conventional hardware devices cannot handle page faults when they try to access the memory subsystem. Therefore, pinning memory for direct memory access is generally a standard practice for conventional data communication applications. The pinned memory accounts for a substantial portion of a total memory and is very expensive (estimated as 40% of the total cost of the conventional responding device (or the server)). However, the memory pinning has adverse effects on memory utilization because the pinned memory cannot be swapped out and limits the ability of the typical operating system (OS) to oversubscribe the memory which in turn lowers the total memory available for other applications. The total memory corresponds to the physical memory as well as to the virtual memory. Additionally, the pinned memory can only be used by a single guest operating system at a time and hence, reduces the total memory available to other virtual machines and different processes. Moreover, a commonly used hypervisor (e.g. a kernel based virtual machine (KVM)) pin the entire memory of virtual machines (VMs) for direct memory access (DMA) and thus, limits the total memory usable by rest of the machines or systems (this process is known as static pinning). Therefore, the memory pinning (or the static memory pinning) leads to an increase in the cost and memory requirements in servers and for this reason, data centres need to supply large quantities of RAM to each server, to account for pinned memory, even if majority of the pinned memory is unused at any given point of time, which is not desirable.

Currently, certain attempts have been made to reduce the cost and memory requirements at servers by use of a conventional non-pinned RDMA technique. The conventional non-pinned RDMA technique provides comparatively better flexibility than pinned RDMA technique in memory management by allowing the memory (i.e. the physical memory content or application virtual memory) to be paged-out and swapping it back in, on demand whenever a RDMA transaction request arrives. However, the conventional non-pinned RDMA technique has technical problems of high transaction drops and therefore, high transaction completion latency and unreliability in a given RDMA system. The conventional non-pinned RDMA technique requires a mechanism that can service a page fault whenever a hardware device tries to obtain a translation for a virtual address (VA) that is currently not in RAM. The conventional non-pinned RDMA technique may be employed on a conventional requesting device (or a conventional requester) and a conventional responding device (or a conventional responder). For example, at the conventional requesting device, the virtual address is known at the time of preparation of a work queue element (WQE). Therefore, the conventional requesting device handles the virtual address (VA)-to-physical address (PA) translation (and page in if required) before a request packet (e.g. a RDMA request packet) is generated. At the conventional responding device, the virtual address is known only when the request packet (i.e. the RDMA request packet) is received over a network. The virtual address is taken either from the request packet header (e.g. in a case of tagged operations) or from the conventional responding device's receive queue (e.g. in a case of untagged operations). After acquiring the virtual address, the conventional responding device usually starts handling the required translation request. If a page fault occurs while handling the translation request, due to an unmapped or swapped out page, a software (or device driver) of the conventional responding device handles the paging or allocation request. Generally, the time required (e.g. up to hundreds of microseconds) to service the page fault is much larger than the time required to transmit or receive a page of data to or from the network at a wire speed (e.g. 25 Gbps-400 Gbps). This means that at least part of the time in the conventional non-pinned RDMA system, the RDMA transaction request is stalled or dropped which in turn increases the transaction completion latency and/or risks the connection to be tear-downed due to different errors. Thus, there exists a technical problem of an inefficient and unreliable data communication by virtue of the conventional requesting device, the conventional responding device, methods, and the conventional remote direct memory access system.

Therefore, in light of the foregoing discussion, there exists a need to overcome the aforementioned drawbacks associated with the conventional requesting device, the conventional responding device, and the conventional methods of the conventional remote direct memory access (RDMA) technique used for data communication.

### SUMMARY

The present disclosure seeks to provide requesting devices, responding devices, and methods for reducing transactions drop in remote direct memory access (RDMA) system. The present disclosure seeks to provide a solution to the existing problem of inefficient and unreliable data communication by virtue of the conventional requesting device, the conventional responding device, methods, and the conventional remote direct memory access system. An aim of the present disclosure is to provide a solution that overcomes at least partially the problems encountered in prior art, and provides improved devices, methods, and an improved RDMA system for an efficient (e.g. reduced transactions drop) and reliable data communication. The object of the present disclosure is achieved by the solutions provided in the enclosed independent claims. Advantageous implementations of the present disclosure are further defined in the dependent claims.

In one aspect, the present disclosure provides a requesting device. The requesting device comprises a memory, a controller and a communication interface. The controller is configured to transmit a message comprising a prefetch operation to a responding device over the communications interface, the prefetch operation indicating a memory area to be loaded by the responding device to a memory of the responding device. The controller is further configured to transmit a request to the responding device over the communications interface, the request relating to request data and to the memory area. The controller is further configured to receive a response message from the responding device over the communications interface.

The requesting device of the present disclosure enables prefetching of required memory pages which may currently be not allocated or swapped out in order to reduce a delay (or a complete transaction latency). The transmission of the message comprising the prefetch operation (or a prefetch hint) before the request (e.g. a RDMA read or a RDMA write request) enables the responding device to prefetch the required memory pages (as per need) ahead of time and makes the preparations to accept the request (i.e. the RDMA read or the RDMA write request) by use of other methods (e.g. scratchpad buffers, memory allocations, etc.). Moreover, if no physical memory buffers are available at the responding device to service the request (i.e. the RDMA read or the RDMA write request), the transmission of the message comprising the prefetch operation (or the prefetch hint) before the request, lowers the probability of dropping or stalling the request (i.e. the RDMA read or the RDMA write request) at the responding device. The disclosed requesting device shares knowledge about a RDMA request (i.e. the RDMA read or the RDMA write request) with the responding device for reducing the probability of stalling or dropping of the RDMA request (i.e. the RDMA read or the RDMA write request) and hence, improves the data communication reliability. The request (i.e. the RDMA read or the RDMA write request) is related to the memory pages which are prefetched by use of the prefetch operation and hence, results into a reduced latency. Additionally, the response message from the responding device acknowledges the requesting device whether the request (i.e. the RDMA read or the RDMA write request) is successfully executed or not and in this way, further improves the reliability and efficiency of the data communication.

In an implementation form, the request is a write command carrying the request data for writing the request data in the memory area, and wherein the response message is an acknowledgement for the write command.

In an example, the request is related to writing the request data at the required memory area (e.g. a memory address) by use of the write command. The requesting device receives the response message which provides the acknowledgement whether the write command is successfully executed or not.

In a further implementation form, the request is a read command carrying a memory address for reading the request data from the memory address in the memory area and the response message is a message carrying the read request data.

In an example, the request is potentially related to reading the request data from the memory address in the memory area by use of the read command. The requesting device receives the response message which provides the read request data on successful execution of the read command.

In a further implementation form, the memory area is of a larger size than the request data. The controller is further configured to transmit a plurality of requests relating to the memory area to the responding device over the communications interface.

In a case a RDMA transaction (e.g. a RDMA read or a RDMA write transaction) involves the exchange of very long messages (or data) e.g. up to 2 Gigabytes (GB) between the requesting device (or initiator) and the responding device (or target). In order to include the exchange of such long messages (e.g. about 2 GB each) the controller is configured to transmit the plurality of requests relating to the memory area of the responding device. Therefore, in such case, the total memory area is larger than the RDMA transaction in order to serve the plurality of requests (or multiple messages) at the same time, possibly between a client (or a single requesting device) and multiple servers (or multiple responding devices) or a server (or a single responding device) and multiple clients (or multiple requesting devices). In cases where the RDMA transaction is larger than the total physical memory size and where the memory is not pinned, the memory may be swapped in and/or out as needed to allow for the larger RDMA transaction to be handled in the context of the virtual memory which is bigger than the RDMA transaction.

In a further implementation form, the controller is further configured to receive an acknowledgement message for the prefetch operation prior to transmitting the request.

The controller of the requesting device receives the acknowledgement message for the prefetch operation prior to transmitting the request indicates that whether the prefetch operation is successfully executed or not. The successful execution of the prefetch operation lowers the probability of stalling the RDMA transaction (i.e. the RDMA read or the RDMA write transaction) and waiting time for retransmission at the responding device. For example, in a case, if the required memory pages are swapped out, then in such a case, the acknowledgement message for the prefetch operation prior to transmitting the request leads to lower latency in comparison to sending a negative acknowledgement (e.g. a receiver not ready (RNR)) or simply dropping the transaction (e.g. the RDMA read or the RDMA write transaction) at the responding device and waiting for a round time objective (RTO (i.e. the maximum amount of time for regaining access to data after an unplanned transaction drop)). In another case, if the required memory pages are not swapped out, then the maximal latency to be considerable is 1 round trip time (RTT).

In a further implementation form, the controller is further configured to transmit the request (e.g. the RDMA read or the RDMA write transaction) after a wait time has lapsed from transmitting the prefetch operation.

The wait time from transmitting the prefetch operation enables the responding device to efficiently execute the request (e.g. the RDMA read or the RDMA write request). Also, the wait time reduces the probability of the request drop at the responding device and hence, makes the data communication more reliable.

In a further implementation form, the message comprising the prefetch operation is a dedicated prefetch operation message.

The dedicated prefetch operation message provides a prefetch hint to the responding device to proactively prefetch the required memory pages (or memory addresses) which are currently not allocated or swapped out and in turn results in to a reduced latency.

In a further implementation form, the message comprising the prefetch operation, comprises the prefetch operation in an additional payload of a request message of another request.

The prefetch operation in the additional payload of the request message of another request enables the responding device to prefetch the required memory pages ahead of time and makes the preparations to efficiently accept the request (i.e. the RDMA read or the RDMA write request).

In a further implementation form, the requesting device is arranged for RDMA.

The requesting device has the capability to perform efficiently in the RDMA.

In another aspect, the present disclosure provides a method for a requesting device. The requesting device comprises a memory, a controller and a communication interface. The method comprises transmitting a message comprising a prefetch operation to a responding device over the communications interface, the prefetch operation indicating a memory area to be loaded by the responding device to a memory of the responding device. The method further comprises transmitting a request to the responding device over the communications interface, the request relating to request data and to the memory area. The method further comprises receiving a response message from the responding device over the communications interface.

The method of this aspect achieves all the advantages and effects of the requesting device of the present disclosure.

In an implementation form, a computer-readable medium carrying computer instructions that when loaded into and executed by a controller of a requesting device enables the requesting device to implement the method.

The computer-readable medium (specifically, a non-transitory computer-readable medium) carrying computer instructions achieves all the advantages and effects of the requesting device, or the method.

In another aspect, the present disclosure provides a requesting device. The requesting device comprises a memory, a communication interface and software modules. The software modules include a prefetch operation message transmitter module for transmitting a message comprising a prefetch operation to a responding device over the communications interface, the prefetch operation indicating a memory area to be loaded by the responding device to a memory of the responding device. The software modules further include a request transmitter module for transmitting a request to the responding device over the communications interface, the request relating to request data and to the memory area. The software modules further include a response message receiver module for receiving a response message from the responding device over the communications interface.

The software module related to the prefetch operation message transmitter module when executed causes the requesting device to transmit the message comprising the prefetch operation to the responding device. The prefetch operation includes prefetching of a required memory area into the memory (e.g. a CPU's cache memory or an internal memory) of the responding device which enables the fast data communication. The software module related to the request transmitter module when executed causes the requesting device to transmit the request (e.g. a read request or a write request) to the responding device. The request is related to the required memory area which is prefetched in to the memory of the responding device hence, results in to a reduced latency (or low response time). The execution of the software module related to the response message receiver module acknowledges the requesting device whether the request (i.e. the read request or the write request) is successfully executed or not which in turn improves the data communication reliability.

In another aspect, the present disclosure provides a responding device. The responding device comprises a memory, a controller and a communication interface. The controller is configured to receive a message comprising a prefetch operation from a requesting device over the communications interface, the prefetch operation indicating a memory area to be loaded by the responding device to the memory. The controller is further configured to load the indicated memory area to the memory. The controller is further configured to receive a request from the requesting device over the communications interface, the request relating to request data and to the memory area. The controller is further configured to execute the request on the request data in the memory area. The controller is further configured to transmit a response message to the requesting device over the communications interface.

The responding device of the present disclosure enables prefetching of required memory by use of the message comprising the prefetch operation from the requesting device. The prefetched memory area is loaded in to the memory (e.g. a CPU's cache or internal memory) of the responding device which enables faster data communication. Moreover, the responding device receives the request relating to request data (e.g. a read request or a write request) and to the memory area (i.e. the prefetched memory area) and therefore, results into the reduced latency. The controller of the responding device transmits the response message to the requesting device in order to provide an acknowledgement whether the request related to the request data and the memory area is successfully executed or not and hence, makes the data communication more reliable.

In an implementation form, the controller is further configured to determine if the memory area is stored in the memory prior to loading the indicated memory area to the memory, and if the memory area is not stored in the memory, load the indicated memory area to the memory.

The controller of the responding device determines the availability of the indicated memory area to the memory or otherwise load the indicated memory area to the memory in order to the probability of stalling the RDMA transactions at the responding device and latency. This further makes the data communication more reliable and faster.

In a further implementation form, the controller is further configured to transmit an acknowledgement message to the requesting device, which acknowledgement message indicates whether the controller was able to load the indicated memory area to the memory or not.

The transmission of the acknowledgement message provides an indication to the requesting device that whether the indicated memory area is loaded to the memory or not. The acknowledgement of this effect may lead to a successful execution of a RDMA transaction and reduces the latency.

In another aspect, the present disclosure provides a method for a responding device. The responding device comprises a memory, a controller and a communication interface. The method comprises receiving a message comprising a prefetch operation from a requesting device over the communications interface, the prefetch operation indicating a memory area to be loaded by the responding device to the memory. The method further comprises loading the indicated memory area to the memory. The method further comprises receiving a request from the requesting device over the communications interface, the request relating to request data and to the memory area. The method further comprises executing the request on the request data in the memory area. The method further comprises transmitting a response message to the requesting device over the communications interface.

The method of this aspect achieves all the advantages and effects of the responding device of the present disclosure.

In an implementation form, a computer-readable medium carrying computer instructions that when loaded into and executed by a controller of a responding device enables the responding device to implement the method.

The computer-readable medium (specifically, a non-transitory computer-readable medium) carrying computer instructions achieves all the advantages and effects of the responding device, or the method.

In another aspect, the present disclosure provides a responding device. The responding device comprises a memory, a communication interface and software modules. The software modules include a prefetch operation receiving module for receiving a message comprising a prefetch operation from a requesting device over the communications interface, the prefetch operation indicating a memory area to be loaded by the responding device to the memory. The software modules further include a memory loading module for loading the indicated memory area to the memory. The software modules further include a request receiving module for receiving a request from the requesting device over the communications interface, the request relating to request data and to the memory area. The software modules further include an execution module for executing the request on the request data in the memory area. The software modules further include a transmitting module for transmitting a response message to the requesting device over the communications interface.

The execution of the prefetch operation receiving module enables the responding device to prefetch the indicated memory area which yields the faster data communication. The execution of the memory loading module for loading the indicated memory area to the memory of the responding device enables a reduced latency. The software module related to the request receiving module is executed for receiving the request related to the request data and to the memory area (e.g. the indicated memory area) and causes a faster processing of the request. The execution module causes the faster execution of the request. Moreover, the transmitting module when executed causes the responding device to transmit the response message which provides an acknowledgement to the requesting device that whether the request is successfully executed or not and hence, improves the data communication reliability.

In another aspect, the present disclosure provides a system. The system comprises the requesting devices and the responding devices according to the aforementioned claims.

The system of the present disclosure provides an improved data communication reliability in terms of the reduced transactions drop (e.g. a RDMA read or a RDMA write transaction) and low latency which in turn speed up the data communication

In another aspect, the present disclosure provides a method for a system. The system comprises a responding device and a requesting device. The method comprises the requesting device transmitting a message comprising a prefetch operation to the responding device, the prefetch operation indicating a memory area to be loaded by the responding device to a memory of the responding device. The method further comprises the responding device receiving the message comprising the prefetch operation and loading the indicated memory area to the memory. The method further comprises the requesting device transmitting a request to the responding device, the request relating to request data and to the memory area. The method further comprises the responding device receiving the request from the requesting device, executing the request on the request data in the memory area and transmitting a response message to the requesting device. The method further comprises the requesting device receiving the response message from the responding device.

The method of this aspect achieves all the advantages and effects of the system of the present disclosure.

It has to be noted that all devices, elements, circuitry, units, modules and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a network environment diagram of an exemplary remote direct memory access (RDMA) system with a requesting device and a responding device, in accordance with an embodiment of the present disclosure.

FIG. 2A is a block diagram that illustrates various exemplary components of a requesting device, in accordance with an embodiment of the present disclosure;

FIG. 2B is a block diagram that illustrates various exemplary components of a responding device, in accordance with an embodiment of the present disclosure;

FIG. 3 is a flowchart of a method for a requesting device, in accordance with an embodiment of the present disclosure;

FIG. 4 is a flowchart of a method for a responding device, in accordance with an embodiment of the present disclosure;

FIG. 5 is a flowchart of a method for a system comprising a requesting device and a responding device, in accordance with an embodiment of the present disclosure; and

FIG. 6 is an illustration of an exemplary scenario of implementation of a remote direct memory access (RDMA) system with a prefetch hint, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

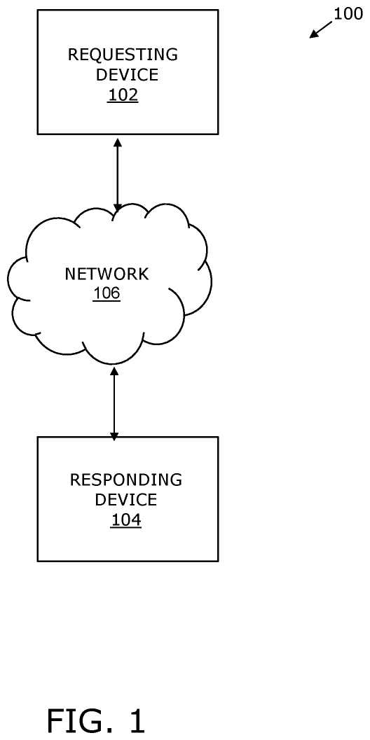

FIG. 1 is a network environment diagram of an exemplary remote direct memory access (RDMA) system with a requesting device and a responding device, in accordance with an embodiment of the present disclosure. With reference to FIG. 1, there is shown a network diagram of a RDMA system 100 that includes a requesting device 102 and a responding device 104. There is further shown a network 106.

In the RDMA system 100, the requesting device 102 can directly access a memory subsystem (e.g. a virtual memory or a portion of total memory (or physical memory)) of the responding device 104 without involving operating system (OS) of the requesting device 102 and the responding device 104. In a conventional RDMA system, the memory subsystem is shared between a user application and a hardware device such as a conventional RDMA network interface card (RNIC). The memory subsystem accessible by the conventional RNIC requires memory pinning, therefore, a user device (required for the user application) have to register for accessing such a memory subsystem under a process known as “register memory region” by use of an InfiniBand (IB) verb. As the user device does not know in prior that which portion of the memory subsystem (or registered memory) is accessed by the conventional RDMA network interface card at any point of time, therefore, such memory subsystem (or registered memory) is often left registered even when not in use. The registration mechanisms for the memory subsystem vary per process therefore, a certain portion of the memory subsystem (or registered memory) cannot be shared between different processes. The registered memory (or pinned memory) leads to high memory requirements to support connectivity in the conventional RDMA system. The various solutions have been proposed in order to efficiently utilize the memory subsystem such as conventional non-pinned direct memory access (NP DMA) solutions. For example, input/output (I/O) bounce buffers, dynamic memory pinning, lazy memory pinning, on-demand paging (ODP), etc. The input/output (I/O) bounce buffers are intermediate buffers which serve as a destination for direct memory access (DMA) operations. However, the input/output (I/O) bounce buffers require additional memory buffers to be allocated at a conventional responding device, also require ongoing management of the buffer pools, incur delays and bus overhead due to additional copying hence, are less preferred. The dynamic and lazy memory pinning require pinning and unpinning of memory on demand therefore, have a complex logic and hard to generalize and optimise and thus, are less used. The on-demand paging (e.g. implemented by Mellanox RNIC) enables prefetching of non-pinned on a local endpoint and requires prefetching to be explicitly activated by an application layer and doesn't relate to hard page fault which include a storage swap device. The RDMA system 100 resolves the aforementioned issues up to a significant extent by enabling prefetching of non-pinned memory by use of a message comprising a prefetch hint. The requesting device 102 transmits the prefetch hint message to the responding device 104. The prefetch hint message enables the responding device 104 to start prefetching of required memory pages (or a portion of the memory subsystem) ahead of time and to make the preparations for accepting one or more data packets. The communication of the prefetch hint message in the RDMA system 100 reduces the probability of stalling or dropping the one or more data packets. In this way, the RDMA system 100 enables a more reliable and an efficient data communication system with a reduced latency over the conventional RDMA system. Additionally, the RDMA system 100 possesses less complexity and is easy to generalise in comparison to the conventional RDMA system and the conventional non-pinned direct memory access solutions.

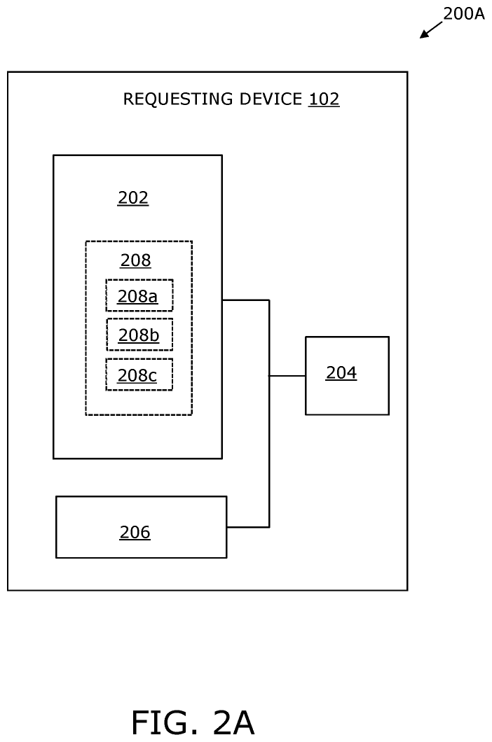

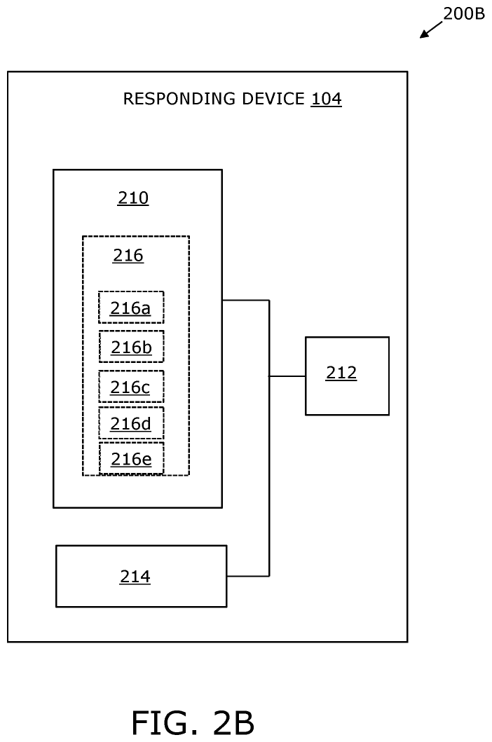

The requesting device 102 includes suitable logic, circuitry, interfaces and/or code that is configured to process a send queue (SQ), to read work queue elements (WQEs) and to generate one or more data packets in order to send to the responding device 104. The data is transferred, for example, in the form of one or more data packets (e.g. a RDMA packet) in the RDMA system 100. The one or more data packets (i.e. the RDMA packet) comprises information related to the packet sequence number (PSN) to enforce correct packet ordering. In an example, the one or more data packets (i.e. the RDMA packet) further comprises source and destination queue pair (QP) numbers, which distinguish an application and valid memory regions for the application. Each QP has a context at the requesting device 102 and the responding device 104 as well. In one embodiment, the memory region has a memory key (R-key) that is part of the one or more data packets, which associates the memory region with the applicant, and vice-versa. The one or more data packets (i.e. the RDMA packet) further comprises information related to a message type (e.g. a RDMA READ, a RDMA WRITE, a SEND, or an ATOMIC) and various parameters of the message (e.g. a message length, a target memory address, an operation type and an operand data). The message length includes the length of the RDMA READ message or the RDMA WRITE message. The memory address includes the target memory address for the RDMA READ message, the RDMA WRITE message and the atomic message. The SEND operation does not have a target memory address. The operation type and operand data exist only for the atomic message type. Additionally, the requesting device 102 transmits the prefetch hint message to the responding device 104 to proactively prefetch the required memory pages (or the portion of the memory subsystem) which is currently not allocated or swapped out. The prefetching of the required memory pages (or the portion of the memory subsystem) reduces the probability of stalling or dropping the one or more data packets (i.e. the RDMA data packet) and thus, improves data communication reliability and latency. The requesting device 102 may also be referred as a requester RDMA network interface card in the RDMA system 100. In an example, the requesting device 102 may be used for high performance computing (HPC). Examples of the requesting device 102 may include, but are not limited to, a network adapter, a server, a computing device in a computer cluster (e.g. massively parallel computer clusters), a communication apparatus including a portable or non-portable electronic device, a telematics control unit (TCU) in a vehicle, a drone, a wireless modem, a supercomputer, or other RDMA-based device. The various exemplary components of the requesting device 102 are described in detail, for example, in FIG. 2A.

The responding device 104 includes suitable logic, circuitry, interfaces and/or code that is configured to process an incoming data packet (i.e. the RDMA data packet), perform operations on the incoming data packet and optionally, returns the information to the requesting device 102. For example, in a case of tagged operations (e.g. the RDMA READ, the RDMA WRITE, or the ATOMIC), the responding device 104 takes the direct memory access (DMA) target (e.g. a virtual address (VA)+message length) from the packet header (e.g. a RDMA extended transport header (RETH) or an atomic extended transport header (Atomic ETH)) of the one or more data packets (e.g. a first data packet) of the RDMA message that goes on a wire. In another case of untagged operations (e.g. the SEND) which have no DMA target (i.e. the virtual address (VA)+message length) in the header, therefore, the responding device 104 determines the DMA target (i.e. the virtual address (VA)+message length) from work queue element (WQE) of a receive queue (RQ). Additionally, the responding device 104 receives the prefetch hint message from the requesting device 102 and prefetches the required memory pages (as per need) ahead of time and makes the preparations to accept a RDMA request (e.g. a RDMA read or a RDMA write request) by use of other methods (e.g. scratchpad buffers, memory allocations, etc.). The prefetch message at the responding device 104 lowers the probability of dropping or stalling the RDMA request (i.e. the RDMA read or the RDMA write request) and hence, supports more reliable and efficient data communication. The responding device 104 may also be referred as a responder RDMA network interface card in the RDMA system 100. Examples of the responding device 104 may include, but are not limited to, a network adapter, a server, a computing device in a computer cluster (e.g. massively parallel computer clusters), a communication apparatus including a portable or non-portable electronic device, a telematics control unit (TCU) in a vehicle, a drone, a wireless modem, a supercomputer, or other RDMA-based device. The various exemplary components of the responding device 104 are explained in detail, for example, in FIG. 2B.

The network 106 includes a medium (e.g. a communication channel) through which the requesting device 102, potentially communicates with the responding device 104. Examples of the network 106 include, but are not limited to, a computer network in a computer cluster, a Local Area Network (LAN), a cellular network, a wireless sensor network (WSN), a cloud network, a vehicle-to-network (V2N) network, a Metropolitan Area Network (MAN), and/or the Internet. The requesting device 102 in the network environment is configured to connect to the responding device 104, in accordance with various network protocols which support RDMA. Examples of such network protocols, communication standards, and technologies may include, but are not limited to, InfiniBand (IB), RDMA over converged Ethernet (RoCE), internet wide area RDMA protocol (iWARP), or modifications and variations thereof, and the like.

FIG. 2A is a block diagram that illustrates various exemplary components of a requesting device, in accordance with an embodiment of the present disclosure. FIG. 2A is described in conjunction with elements from FIG. 1. With reference to FIG. 2A, there is shown a block diagram 200A of the requesting device 102. The requesting device 102 comprises a memory 202 a controller 204 and a communication interface 206. In an implementation, the requesting device 102 further comprises one or more software modules, such as software modules 208.

The memory 202 includes suitable logic, circuitry, and/or interfaces that is configured to store instructions executable to control the requesting device 102. The memory 202 may store data (communicated in the form of data packets) for processing at the requesting device 102. Examples of implementation of the memory 202 may include, but are not limited to, Random Access Memory (RAM), Electrically Erasable Programmable Read-Only Memory (EEPROM), Read Only Memory (ROM), Hard Disk Drive (HDD), Flash memory, a Secure Digital (SD) card, Solid-State Drive (SSD), and/or CPU cache memory. The memory 202 may store an operating system and/or other program products to operate the requesting device 102. A computer readable storage medium for providing a non-transient memory may include, but is not limited to, an electronic storage device, a magnetic storage device, an optical storage device, an electromagnetic storage device, a semiconductor storage device, or any suitable combination of the foregoing.

The controller 204 includes suitable logic, circuitry, and/or interfaces that is configured to transmit a message comprising a prefetch operation to the responding device 104 over the communications interface 206, the prefetch operation indicating a memory area to be loaded by the responding device 104 to a memory of the responding device 104. The controller 204 is a computational element that is configured to processes instructions that drive the requesting device 102. Examples of the controller 204 includes, but are not limited to, a network interface controller, a microprocessor, a microcontroller, a complex instruction set computing (CISC) microprocessor, a reduced instruction set (RISC) microprocessor or a very long instruction word (VLIW) microprocessor.

The communication interface 206 is an arrangement of interconnected programmable and/or non-programmable components that are configured to facilitate data communication between one or more electronic devices. For example, a network interface card (NIC) is arranged in the communication interface 206 to process a send queue (SQ) WQEs, read work queue elements (WQEs) and generates data packets to send to the responding device 104. Additionally, the network interface card arranged in the communication interface 206 can process a receive queue WQEs and incoming write requests (for example, the requesting device 102 may also function as the responding device 104). The communication interface 206 may support communication protocols for one or more of peer-to-peer network, a hybrid peer-to-peer network, local area networks (LANs), radio access networks (RANs), metropolitan area networks (MANs), wide area networks (WANs), all or a portion of a public network such as the global computer network known as the Internet, a private network, a cellular network and any other communication system or systems at one or more locations. Additionally, the communication interface 206 supports wired or wireless communication that can be carried out via any number of known protocols, including, but not limited to, Internet Protocol (IP), Wireless Access Protocol (WAP), Frame Relay, or Asynchronous Transfer Mode (ATM). Moreover, any other suitable protocols using voice, video, data, or combinations thereof, can also be employed and supported by the communication interface 206.

In an exemplary implementation, the software modules 208 include a prefetch operation message transmitter module 208a, a request transmitter module 208b, and a response message receiver module 208c. In an implementation, the software modules 208 (which includes the software modules 208a to 208c) are potentially implemented as separate circuits in the requesting device 102. Alternatively, in another implementation, the software modules 208 are implemented as a circuitry to execute various operations of software modules 208a to 208c.

In operation, the controller 204 is configured to transmit a message comprising a prefetch operation to a responding device (such as the responding device 104) over the communications interface 206, the prefetch operation indicating a memory area to be loaded by the responding device 104 to a memory of the responding device 104. The message comprising the prefetch operation enables the responding device 104 to prefetch the indicated memory area ahead of time and to load the indicated memory area to the memory of the responding device 104 which results into low latency. In a case, the memory of the responding device 104 may be a higher-level memory such as a CPU's cache memory or an internal memory which in turn speed up the data communication in the RDMA system 100 (of FIG. 1). At the requesting device 102, the message comprising the prefetch operation (or a prefetch hint message) can be generated automatically at a transmitted data path (i.e. a path followed by different data packets for transmission from the requesting device 102 to the responding device 104). Therefore, the information about the indicated memory area (or targeted memory ranges) at the responding device 104 is available in the transmitted data path. Optionally, the generation of the message comprising the prefetch operation may be controlled by a RDMA network interface card (RNIC) firmware (FW). In another alternative way, the prefetch operation at the responding device 104 (after the message comprising the prefetch operation is received) can be delegated from the RDMA network interface card (RNIC) hardware (HW) to various other devices such as the RDMA network interface card (RNIC) firmware (FW), or a system memory management unit (MMU), or input/output (I/O) MMU hardware, a device driver, an operating system (OS) kernel, or a hypervisor (e.g. a virtual machine monitor (VMM)). The prefetch operation at the responding device 104 can be distributed between any of the aforementioned devices.

The controller 204 is further configured to transmit a request to the responding device 104 over the communications interface 206, the request relating to request data and to the memory area. For example, the request relating to request data and to the memory area may also be referred as a RDMA message which can be either write to the indicated memory area of the responding device 104 or read from the indicated memory area of the responding device 104. The RDMA message is transmitted from the requesting device 102 to the responding device 104 in the form of various data packets (e.g. a RDMA data packet). The RDMA data packets comprise information related to the RDMA message type (e.g. a RDMA READ, a RDMA WRITE, a SEND, or an ATOMIC) and various parameters of the RDMA message (e.g. a message length, a target memory address, an operation type and an operand data).

The controller 204 is further configured to receive a response message from the responding device 104 over the communications interface 206. The response message from the responding device 104 acknowledges the controller 204 of the requesting device 102 that whether the request relating to request data and the memory area is successfully executed or not. Additionally, the response message transmits the request data to the requesting device 102. For example, in a case of a read request, which includes reading a request data from the indicated memory area. In this case, the response message transmits the request data to the requesting device 102.

The prefetch operation provides a capability to the requesting device 102 to enable prefetching of required memory pages at the responding device 104 which may currently be not allocated or swapped out in order to reduce a delay (or a complete transaction latency). The transmission of the message comprising the prefetch operation (or a prefetch hint) before the request (e.g. a RDMA read or a RDMA write request) enables the responding device 104 to prefetch the required memory pages (as per need) ahead of time and makes the preparations to accept the request (i.e. the RDMA read or the RDMA write request) by use of other methods (e.g. scratchpad buffers, memory allocations, etc.). Moreover, if no physical memory buffers are available at the responding device 104 to service the request (i.e. the RDMA read or the RDMA write request), the transmission of the message comprising the prefetch operation (or the prefetch hint) before the request, lowers the probability of dropping or stalling the request (i.e. the RDMA read or the RDMA write request) at the responding device 104. As the requesting device 102 shares knowledge about a RDMA request (i.e. the RDMA read or the RDMA write request) with the responding device 104 for reducing the probability of stalling or dropping of the RDMA request (i.e. the RDMA read or the RDMA write request), the data communication reliability is significantly improved as compared to conventional RDMA systems, which suffers from high transactions drops and therefore, high transaction latency and data unreliability.

For example, in the conventional RDMA system with non-pinned memory approach, no prefetch hint message (or prefetch hint packet) is used. The conventional requesting device transmits a request (e.g. a write request such as WRITE (VA 0x1000)) to the conventional responding device without any prefetch hint message. The conventional responding device finds that the indicated memory address (i.e. VA 0x1000) is paged out and therefore, the conventional responding device transmits a negative acknowledgement message (e.g. RNR (receiver not ready)) to the conventional requesting device. After receiving the negative acknowledgement message (i.e. RNR (receiver not ready)), the conventional requesting device waits for the RNR timeout and retransmits the original request (i.e. the write request such as WRITE (VA 0x1000)) to the conventional responding device. In the meantime (i.e. from transmitting the negative acknowledgement message (i.e. RNR (receiver not ready)) to receiving the original request again), the conventional responding device starts page in for the memory address (i.e. VA 0x1000) and makes the memory address ready to accept the request (i.e. the request which is retransmitted by the conventional requesting device). In this way, the conventional RDMA system has technical problems of high transactions drop and therefore, high transaction latency and data unreliability. However, in the RDMA system 100, the requesting device 102 transmits the prefetch hint message to the responding device 104 and enables the responding device 104 to prefetch the indicated memory area ahead of time. This effect reduces the transactions drop at the responding device 104 which further results in low transaction latency and an improved data reliability and efficiency.

In accordance with an embodiment, the controller 204 is further configured to receive an acknowledgement message for the prefetch operation prior to transmitting the request. The acknowledgement message (e.g. ACKREQ bit) for the prefetch operation provides an information to the controller 204 of the requesting device 102 that whether the prefetch operation (i.e. loading of the indicated memory area to the memory of the responding device 104) is successfully completed or not. The acknowledgement message (i.e. ACKREQ bit) can be either a regular InfiniBand acknowledgement (IB ACK) message or a new special data packet or a header or any other way to signal (or inform) the requesting device 102 about the execution of the prefetch operation. The reception of the acknowledgement message (i.e. ACKREQ bit) at the requesting device 102 before transmitting the request (e.g. a RDMA message) reduces the probability of stalling or dropping the request at the responding device 104 and also yields lower latency. Moreover, the acknowledgement message (i.e. ACKREQ bit) reduces the probability of getting a negative acknowledgement message (e.g. a receiver-not-ready (RNR)) at the requesting device 102. The acknowledgement message (i.e. ACKREQ bit) for the prefetch operation is like a fencing of the request that is related to request data and the memory area. The fencing of the request means that the request is transmitted only after the acknowledgement message is received at the controller 204 of the requesting device 102. For example, in an implementation, the fencing of the request can be either implicit or happen dynamically. In another implementation, the fencing of the request may be either configurable or negotiated between the requesting device 102 and the responding device 104.

In accordance with an embodiment, the message comprising the prefetch operation is a dedicated prefetch operation message. The message comprising the prefetch operation may also be referred as either a prefetch hint message or a prefetch hint packet. For example, in a case, the prefetch hint message (or the prefetch hint packet) is transmitted as the dedicated prefetch operation message (or a special packet). In that case, the requesting device 102 may ask for an acknowledgement (i.e. the acknowledgement message (i.e. ACKREQ bit)) of the prefetch hint message and wait for the acknowledgement. The requesting device 102 while processing the WQEs, the RDMA network interface card (RNIC) that is arranged on the communications interface 206 creates a packet with a new base transport header (BTH) operation code (OPCODE), which is known as the prefetch hint message (or the prefetch hint packet). For tagged requests (e.g. the RDMA READ, the RDMA WRITE, or the ATOMIC), the prefetch hint message (or the prefetch hint packet) comprises a target direct memory access (DMA) that includes various parameters such as R_KEY, virtual address (VA), and length (i.e. R_KEY+VA+length) at the responding device 104. For untagged requests (e.g. the SEND), the prefetch hint message (or the prefetch hint packet) comprises a SEND sequence ID (and optionally, length), which determines the responding device 104 (or the responder's) receive queue element (RQE) index, which further provides the DMA target at the responding device 104. The prefetch hint message (or the prefetch hint packet) is transmitted to the responding device 104 on a wire prior to the request (e.g. the RDMA message) relating to the request data and to the memory area.

In accordance with an embodiment, the message comprising the prefetch operation, comprises the prefetch operation in an additional payload of a request message of another request. For example, the prefetch hint message (or the prefetch hint packet) can be transmitted as the additional payload in the other request (or existing data packets). Optionally, instead of the new base transport header (BTH) operation code (OPCODE), a new header may be added to the other request (or the existing data packets) in order to transmit the prefetch hint message (or the prefetch hint packet). Alternatively, instead of the new operation code (OPCODE), existing opcodes may also be used with special flags (e.g. 0-sized READ/WRITE flag). In another alternative, the prefetch hint message (or the prefetch hint packet) may be activated explicitly at application layer (e.g. a new InfiniBand (IB) verb).

In accordance with an embodiment, the controller 204 is further configured to transmit the request after a wait time has lapsed from transmitting the prefetch operation. For example, in a case, the wait time from transmitting the prefetch hint message (or the prefetch hint packet) is required for receiving an acknowledgement (i.e. the acknowledgement message) of the prefetch operation. The wait time reduces the probability of the request drop at the responding device 104 and hence, makes the data communication more reliable.

In accordance with an embodiment, the request is a write command carrying the request data for writing the request data in the memory area, and wherein the response message is an acknowledgement for the write command. For example, in a case, the request is the write command and carries the request data for writing the request data at the indicated memory area to the memory of the responding device 104. In that case, the response message from the responding device 104 provides the acknowledgement (or information) to the requesting device 102 that the write command is successfully executed. Optionally, the response message may provide a negative acknowledgement (NAK) to the requesting device 102 to inform that the write command is not successfully executed.

Optionally, in an exemplary implementation, the request (i.e. the request transmitted by the controller 204 after a wait time has lapsed from transmitting the prefetch operation), relates to a remote procedure call (RPC). In the RPC, the requesting device 102 (or a client) transmits a procedure or a function to the responding device 104 (or a server) over a network (such as the network 106). The RPC causes the procedure or the function to execute at a different memory address (i.e. different from memory addresses of the requesting device 102) in the responding device 104. The responding device 104 (or the server) executes the procedure or the function and transmits a response message (i.e. having reply parameters of the procedure or the function) to the requesting device 102. The requesting device 102 is potentially blocked while the responding device 104 is processing the procedure or the function and resumed only when the responding device 104 is finished the execution of the procedure or the function.

Optionally, in another exemplary implementation, the request relates to an artificial intelligence operation. Generally, the artificial intelligence (AI) operation refers to design of an intelligent machine (more particularly an intelligent computer program) which is able to perceive inputs from an environment, learn from such inputs and provides a related and flexible behaviour which resembles to a human behaviour based on the same inputs. The artificial intelligence (AI) operation requires high performance computing or super-computing. The requesting device 102 while executing the artificial intelligence operation knows in advance that which memory address needs to be loaded by the responding device 104. Moreover, the requesting device 102 is able to adapt according to different network conditions by use of the artificial intelligence operation.

In accordance with an embodiment, the request is a read command carrying a memory address for reading the request data from the memory address in the memory area and the response message is a message carrying the read request data. For example, in a case, the request is the read command and carries the memory address for reading the request data. The memory address lies in the indicated memory area to the memory of the responding device 104. In that case, the response message from the responding device 104 provides the read request data to the requesting device 102.

Optionally, the request potentially relates to a storage operation. The storage operation may require an additional memory (i.e. other than the memory 202 of the requesting device 102), for example, in an artificial intelligence operation or a remote procedure call. Therefore, the requesting device 102 transmits the request related to the storage operation to the responding device 104 in order to get an access to the additional memory (that may be a part of the memory of the responding device 104). In this way, the storage operation can be executed more efficiently in the RDMA system 100.

In accordance with an embodiment, the memory area is of a larger size than the request data and wherein the controller 204 is further configured to transmit a plurality of requests relating to the memory area to the responding device 104 over the communications interface 206. The RDMA system 100 (of FIG. 1) allows the exchange of very long messages (or data packets) e.g. up to 2 Gigabytes (GB) between the requesting device 102 (or initiator) and the responding device 104 (or target). In order to include the exchange of such long messages (i.e. up to 2 GB) the controller 204 is configured to transmit the plurality of requests relating to the memory area of the responding device 104. Therefore, in such case, the total memory area is larger than RDMA transaction in order to serve the plurality of requests (or multiple messages) at the same time, possibly between a client and multiple servers or a server and multiple clients. In cases where the RDMA transaction is larger than the total physical memory size and where the memory is not pinned, the memory may be swapped in and/or out as needed to allow for the larger RDMA transaction to be handled in the context of the virtual memory which is bigger than the RDMA transaction.

In accordance with an embodiment, the requesting device 102 is arranged for RDMA. The requesting device 102 (or the requester) processes a send queue (SQ) WQEs, reads work queue elements (WQEs) and generates data packets in order to send to the responding device 104 in the RDMA system 100. Additionally, the requesting device 102 can process a receive queue (RQ) WQEs and incoming write requests (for example, the requesting device 102 may also function as the responding device 104).

In an exemplary aspect, the requesting device 102 comprises the memory 202, the communication interface 206 and the software modules 208. The software modules 208 when executed (e.g. by the controller 204) causes the requesting device 102 to perform various operations, as described below in an example. The software modules 208 include the prefetch operation message transmitter module 208a for transmitting a message comprising a prefetch operation to the responding device 104 over the communications interface 206, the prefetch operation indicating a memory area to be loaded by the responding device 104 to a memory of the responding device 104. The software modules 208 further include the request transmitter module 208b for transmitting a request to the responding device 104 over the communications interface 206, the request relating to request data and to the memory area. The software modules 208 further include the response message receiver module 208c for receiving a response message from the responding device 104 over the communications interface 206.

In the exemplary aspect, the prefetch operation message transmitter module 208a when executed causes the requesting device 102 to transmit the message comprising the prefetch operation to the responding device 104 which enables the responding device 104 to prepare the indicated memory area and to load the indicated memory area to the memory of the responding device 104 which provides a faster data communication. Optionally, an acknowledgement message is transmitted to the requesting device 102 which provides an information that whether the prefetch operation is successfully completed or not. The request transmitter module 208b when executed causes the requesting device 102 to transmit the request relating to request data and to the memory area (i.e. the indicated memory area) to the responding device 104. The request relating to request data can be a RDMA READ request, a RDMA WRITE request, a SEND request, or an ATOMIC request. The response message receiver module 208c when executed causes the requesting device 102 to receive the response message from the responding device 104 in order to get informed about the successful execution of the request relating to request data and to the memory area which makes the data communication more reliable. The software modules 208 are executed by the controller 204 of the requesting device 102.

Thus, the requesting device 102 enables a more reliable and an efficient data communication system (i.e. the RDMA system 100) with a reduced latency by transmitting the prefetch hint message to the responding device 104.

FIG. 2B is a block diagram that illustrates various exemplary components of a responding device, in accordance with an embodiment of the present disclosure. FIG. 2B is described in conjunction with elements from FIGS. 1 and 2A. With reference to FIG. 2B, there is shown a block diagram 200B of the responding device 104 (of FIG. 1). The responding device 104 includes a memory 210, a controller 212 and a communications interface 214. In an implementation, the responding device 104 further includes one or more software modules, such as software modules 216.

The memory 210 includes suitable logic, circuitry, and/or interfaces that is configured to store instructions executable to control the responding device 104. The memory 210 may store data (communicated in the form of data packets) for processing at the responding device 104. Examples of implementation of the memory 210 may include, but are not limited to, Random Access Memory (RAM), Electrically Erasable Programmable Read-Only Memory (EEPROM), Read Only Memory (ROM), Hard Disk Drive (HDD), Flash memory, a Secure Digital (SD) card, Solid-State Drive (SSD), and/or CPU cache memory. The memory 210 may store an operating system and/or other program products to operate the responding device 104. A computer readable storage medium for providing a non-transient memory may include, but is not limited to, an electronic storage device, a magnetic storage device, an optical storage device, an electromagnetic storage device, a semiconductor storage device, or any suitable combination of the foregoing.

The controller 212 includes suitable logic, circuitry, and/or interfaces that is configured to receive a message comprising a prefetch operation from a requesting device (such as the requesting device 102) over the communications interface 214, the prefetch operation indicating a memory area to be loaded by the responding device 104 to the memory 210. The controller 212 is a computational element that is configured to process the instructions that drive the responding device 104. Examples of the controller 212 includes, but are not limited to, a network interface controller, a microprocessor, a microcontroller, a complex instruction set computing (CISC) microprocessor, a reduced instruction set (RISC) microprocessor or a very long instruction word (VLIW) microprocessor

The communication interface 214 is an arrangement of interconnected programmable and/or non-programmable components that are configured to facilitate data communication between one or more electronic devices. For example, a network interface card (NIC) is arranged in the communications interface 214 to process incoming messages (or data packets) and to perform various operations on the incoming messages. Furthermore, the communications interface 214 supports communication via various networks, such as a peer-to-peer network, a hybrid peer-to-peer network, local area networks (LANs), radio access networks (RANs), metropolitan area networks (MANs), wide area networks (WANs), all or a portion of a public network such as the global computer network known as the Internet, a private network, a cellular network and any other communication system or systems at one or more locations. Additionally, the communication interface 214 supports wired or wireless communication that can be carried out via any number of known protocols, including, but not limited to, Internet Protocol (IP), Wireless Access Protocol (WAP), Frame Relay, or Asynchronous Transfer Mode (ATM).

In an exemplary implementation, the software modules 216 include a prefetch operation receiving module 216a, a memory loading module 216b, a request receiving module 216c, an execution module 216d and a transmitting module 216e. In an implementation, the software modules 216 (which includes the software modules 216a to 216e) are potentially implemented as separate circuits in the responding device 104. Alternatively, in another implementation, the software modules 216 are implemented as a circuitry to execute various operations of software modules 216a to 216e.

In operation, the controller 212 is configured to receive a message comprising a prefetch operation from a requesting device (such as the requesting device 102) over the communications interface 214, the prefetch operation indicating a memory area to be loaded by the responding device 104 to the memory 210. The controller 212 of the responding device 104 receives the message comprising the prefetch operation and prefetches the indicated memory area ahead of time and loads the indicated memory area to the memory 210 of the responding device 104. The message comprising the prefetch operation reduces the probability of dropping or stalling a RDMA request (e.g. a RDMA write or a RDMA read request) at the responding device 104 and hence, supports more reliable and efficient data communication.

The controller 212 is further configured to load the indicated memory area to the memory 210. The controller 212 loads the indicated memory area to the memory 210 of the responding device 104. For example, in a case, the memory 210 of the responding device 104 may belong to a higher-level memory such as a CPU's cache memory or an internal memory (e.g. a random access memory (RAM)) to enable low latency or faster data communication. It is to be understood by one of ordinary skill in the art that the memory 210 may also be part of the host machine where host central processing unit (CPU) is located (e.g. the responding device 104 is used as the host machine).

The controller 212 is further configured to receive a request from the requesting device 102 over the communications interface 214, the request relating to request data and to the memory area. The controller 212 receives the request relating to request data and to the memory area (i.e. the indicated memory area). The request being related to the memory area (i.e. the indicated memory area) enables a faster transaction. For example, in a case, the request may be a read request and carries a memory address for reading the request data. The memory address lies within the indicated memory area. In another case, the request may be a write request for writing the request data to the indicted memory area. Thus, there is possibility that the request will differ for different application scenarios.

The controller 212 is further configured to execute the request on the request data in the memory area. The controller 212 executes the request (i.e. the read request or the write request) on the request data in the indicated memory area of the memory 210 of the responding device 104.

The controller 212 is further configured to transmit a response message to the requesting device 102 over the communications interface 214. The controller 212 transmits the response message to the requesting device 102 to provide an information about the successful execution of the request. The response message enables the commencement of another request from the requesting device 102 towards the responding device 104.

In accordance with an embodiment, the controller 212 is further configured to determine if the memory area is stored in the memory 210 prior to loading the indicated memory area to the memory 210, and if the memory area is not stored in the memory 210, load the indicated memory area to the memory 210. For example, in a case, if the memory area is not swapped out and already stored in the memory 210 of the responding device 104. In such a case, the loading step may be removed. Therefore, prior to loading the indicated memory area to the memory 210, the controller 212 determines whether the memory area is stored in the memory 210 or not. In another case, if the memory area is swapped out and not stored in the memory 210. Then in such a case, the controller 212 loads the indicated memory area to the memory 210 of the responding device 104. In a yet another case, the indicated memory area is loaded to a smaller portion of the memory 210 of the responding device 104 only for a short duration (i.e. the time up to which the request is processed), also known as partial memory loading.

In accordance with an embodiment, the controller 212 is further configured to transmit an acknowledgement message to the requesting device 102, which acknowledgement message indicates whether the controller 212 was able to load the indicated memory area to the memory 210 or not. The acknowledgement message from the controller 212 provides an information to the requesting device 102 that the indicated memory area is ready to accept the request relating to request data and to the memory area (e.g. a RDMA read request or a RDMA write request). The acknowledgement message reduces the transaction drop (or request drop) at the responding device 104 and hence, enables reliable and efficient data communication.

In an exemplary aspect, the responding device 104 comprises the memory 210, the communication interface 214 and the software modules 216. The software modules 216 when executed (e.g. by the controller 212) causes the responding device 104 to perform various operations, as described below in an example. The software modules 216 include the prefetch operation receiving module 216a for receiving a message comprising a prefetch operation from a requesting device (such as the requesting device 102) over the communications interface 214, the prefetch operation indicating a memory area to be loaded by the responding device 104 to the memory 210. The software modules 216 further include the memory loading module 216b for loading the indicated memory area to the memory 210. The software modules 216 further include the request receiving module 216c for receiving a request from the requesting device 102 over the communications interface 214, the request relating to request data and to the memory area. The software modules 216 further include the execution module 216d for executing the request on the request data in the memory area. The software modules 216 further include the transmitting module 216e for transmitting a response message to the requesting device 102 over the communications interface 214.

In the exemplary aspect, the prefetch operation receiving module 216a when executed causes the responding device 104 to receive the message comprising the prefetch operation. The responding device 104 prefetches the indicated memory area ahead of time and thus, enables lower latency. The memory loading module 216b when executed causes the responding device 104 to load the indicated memory area to the memory 210 of the responding device 104. The request receiving module 216c when executed causes the responding device 104 to receive the request relating to request data and to the memory area (i.e. the indicated memory area). The request relating to request data can be a RDMA READ request, a RDMA WRITE request, a SEND request, or an ATOMIC request. The execution module 216d when executed causes the responding device 104 to execute the request on the request data at the indicated memory area. The transmitting module 216e when executed causes the responding device 104 to transmit the response message to the requesting device 102 to provide an information about the successful execution of the request. The software modules 216 are executed by the controller 212 of the responding device 104.

Thus, the responding device 104 reduces the request drop (or the transactions drop) and retransmission time by prefetching the indicated memory area (or the required memory regions) ahead of time. The responding device 104 makes all the preparations before accepting the request (i.e. the RDMA request) and processes and executes the request more reliably and efficiently.

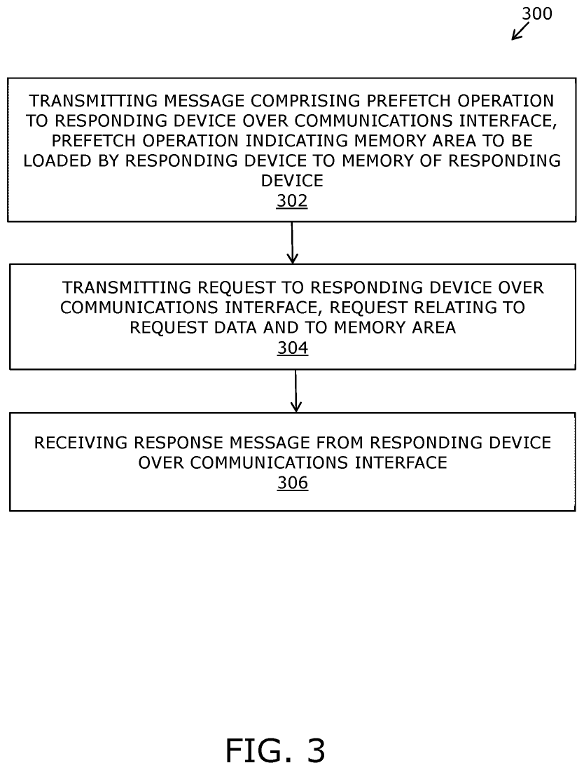

FIG. 3 is a flowchart of a method for a requesting device, in accordance with an embodiment of the present disclosure. FIG. 3 is described in conjunction with elements from FIGS. 1, 2A, and 2B. With reference to FIG. 3 there is shown a method 300 to reduce RDMA transactions drop (or RDMA requests drop) in a remote direct memory access system (e.g. the RDMA system 100). The method 300 is executed by the controller 204 of the requesting device 102 which has been described in detail, for example, in FIGS. 1, and 2A. The method 300 includes steps 302 to 306.

At step 302, the method 300 comprises transmitting a message comprising a prefetch operation to a responding device (such as the responding device 104) over the communications interface 206, the prefetch operation indicating a memory area to be loaded by the responding device 104 to a memory of the responding device 104. The message comprising the prefetch operation (or a prefetch hint message) enables the responding device 104 to prefetch the indicated memory area to the memory (such as the memory 210) ahead of time which further enables fast and reliable execution of a RDMA transaction (or a RDMA request (e.g. a RDMA read request or a RDMA write request)). The prefetching of the indicated memory area at the responding device 104 reduces the probability of the RDMA transaction drop (or the RDMA request drop) at the responding device 104. The controller 204 of the requesting device 102 is configured to transmit the message comprising the prefetch operation (or the prefetch hint message) to the responding device 104 over the communication interface 206.

At step 304, the method 300 further comprises transmitting a request to the responding device 104 over the communications interface 206, the request relating to request data and to the memory area. The request relating to request data and to the memory area (i.e. the indicated memory area) corresponds to the RDMA transaction (or the RDMA request) which is executed by the controller 212 of the responding device 104. The request may be either a RDMA read request, a RDMA write request, a SEND request or an ATOMIC request. The controller 204 of the requesting device 102 is configured to transmit the request to the responding device 104 over the communication interface 206.

At step 306, the method 300 further comprises receiving a response message from the responding device 104 over the communications interface 206. The response message from the responding device 104 informs the requesting device 102 that whether the request (i.e. the RDMA request) relating to request data and to the memory area is successfully executed or not at the responding device 104. The controller 204 of the requesting device 102 is configured to receive the response message from the responding device 104 over the communications interface 206.

The steps 302 to 306 are only illustrative and other alternatives can also be provided where one or more steps are added, one or more steps are removed, or one or more steps are provided in a different sequence without departing from the scope of the claims herein.

In accordance with an embodiment, a computer-readable medium carrying computer instructions that when loaded into and executed by a controller (such as the controller 204) of a requesting device (such as the requesting device 102) enables the requesting device 102 to implement the method 300. A computer-readable medium carrying computer instructions provide a non-transient memory may include, but is not limited to, an electronic storage device, a magnetic storage device, an optical storage device, an electromagnetic storage device, a semiconductor storage device, or any suitable combination of the foregoing.

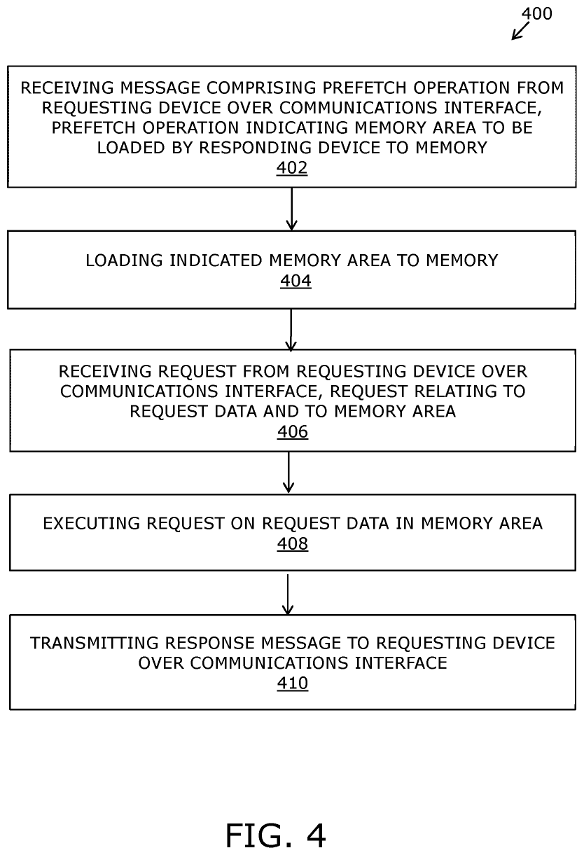

FIG. 4 is a flowchart of a method for a responding device, in accordance with an embodiment of the present disclosure. FIG. 4 is described in conjunction with elements from FIGS. 1, 2A, 2B, and 3. With reference to FIG. 4 there is shown a method 400 to reduce RDMA transactions drop (or RDMA requests drop) in a remote direct memory access system (e.g. the RDMA system 100). The method 400 is executed by the controller 212 of the responding device 104 which has been described in detail, for example, in FIGS. 1 and 2B. The method 400 includes steps 402 to 410.

At step 402, the method 400 comprises receiving a message comprising a prefetch operation from a requesting device (such as the requesting device 102) over the communications interface 214, the prefetch operation indicating a memory area to be loaded by the responding device 104 to the memory 210. The responding device 104 prefetches the indicated memory area according to the message comprising the prefetch operation. The controller 212 of the responding device 104 loads the indicated memory area to the memory 210 of the responding device 104. The prefetching of the indicated memory area by the responding device 104 prior to receiving a RDMA request reduces the probability of the RDMA request drop, hence, improves data communication reliability and efficiency of the RDMA system 100 (of FIG. 1). The controller 212 of the responding device 104 is configured to receive the message comprising the prefetch operation from the requesting device 102 over the communications interface 214.

At step 404, the method 400 further comprises loading the indicated memory area to the memory 210. The controller 212 of the responding device 104 is configured to load the indicated memory area to the memory 210 of the responding device 104. The memory 210 the responding device 104 may be a higher-level memory such as either a CPU's cache memory or an internal memory (e.g. random access memory (RAM)). The higher-level memory enables a faster transaction (i.e. the RDMA transaction) with very low latency.

At step 406, the method 400 further comprises receiving a request from the requesting device 102 over the communications interface 214, the request relating to request data and to the memory area. The controller 212 of the responding device 104 is configured to receive the request relating to request data and to the memory area (i.e. the indicated memory area) from the requesting device 102 over the communications interface 214.

At step 408, the method 400 further comprises executing the request on the request data in the memory area. The controller 212 of the responding device 104 is configured to execute the request on the request data in the memory area. The memory area corresponds to the indicated memory area which is loaded to the memory 210 of the responding device 104.

At step 410, the method 400 further comprises transmitting a response message to the requesting device 102 over the communications interface 214. The controller 212 of the responding device 104 is configured to transmit the response message to the requesting device 102 over the communications interface 214. The response message acknowledges the requesting device 102 about the successful execution of the request at the responding device 104.

The steps 402 to 410 are only illustrative and other alternatives can also be provided where one or more steps are added, one or more steps are removed, or one or more steps are provided in a different sequence without departing from the scope of the claims herein.

In accordance with an embodiment, a computer-readable medium carrying computer instructions that when loaded into and executed by the controller 212 of the responding device 104 enables the responding device 104 to implement the method 400. The computer-readable medium carrying computer instructions provides a non-transient memory may include, but is not limited to, an electronic storage device, a magnetic storage device, an optical storage device, an electromagnetic storage device, a semiconductor storage device, or any suitable combination of the foregoing.

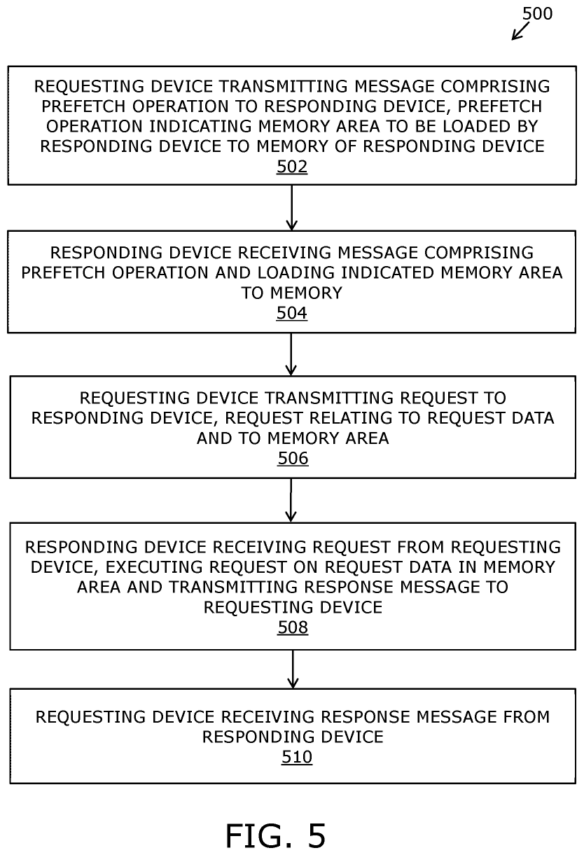

FIG. 5 is a flowchart of a method for a system comprising a requesting device and a responding device, in accordance with an embodiment of the present disclosure. FIG. 5 is described in conjunction with elements from FIGS. 1, 2A, 2B, 3, and 4. With reference to FIG. 5 there is shown a method 500 for a remote direct memory access system (e.g. the RDMA system 100) that includes a requesting device (e.g. the requesting device 102) and a responding device (e.g. the responding device 104). The method 500 is executed by the RDMA system 100 which has been described in detail, for example, in FIG. 1. The method 500 includes steps 502 to 510.

At step 502, the method 500 comprises the requesting device 102 transmitting a message comprising a prefetch operation to the responding device 104, the prefetch operation indicating a memory area to be loaded by the responding device 104 to a memory (e.g. the memory 210) of the responding device 104. The message comprising the prefetch operation includes prefetching of the indicated memory area at the responding device 104 which further speed up the data communication in the RDMA system 100.

At step 504, the method 500 further comprises the responding device 104 receiving the message comprising the prefetch operation and loading the indicated memory area to the memory 210. The controller 212 of the responding device 104 is configured to load the indicated memory area to the memory 210 of the responding device 104.

At step 506, the method 500 further comprises the requesting device 102 transmitting a request to the responding device 104, the request relating to request data and to the memory area. The controller 204 of the requesting device 102 is configured to transmit the request to the responding device 104 over the communications interface 206. The request (or a RDMA transaction) relating to request data and to the memory area can be either reading the request data from the memory area or writing the request data to the memory area or storing the request data to the memory area or many alike.

At step 508, the method 500 further comprises the responding device 104 receiving the request from the requesting device 102, executing the request on the request data in the memory area and transmitting a response message to the requesting device 102. The controller 212 of the responding device 104 is configured to receive the request (i.e. the RDMA transaction) from the requesting device 102. The controller 212 of the responding device 104 is further configured to execute the request on the request data in the memory area. The controller 212 of the responding device 104 is further configured to transmit the response message to the requesting device 102.

At step 510, the method 500 further comprises the requesting device 102 receiving the response message from the responding device 104. The controller 204 of the requesting device 102 is configured to receive the response message from the responding device 104. The response message provides an information to the requesting device 102 that whether the request relating to the request data and to the memory area is successfully executed or not.

The steps 502 to 510 are only illustrative and other alternatives can also be provided where one or more steps are added, one or more steps are removed, or one or more steps are provided in a different sequence without departing from the scope of the claims herein.

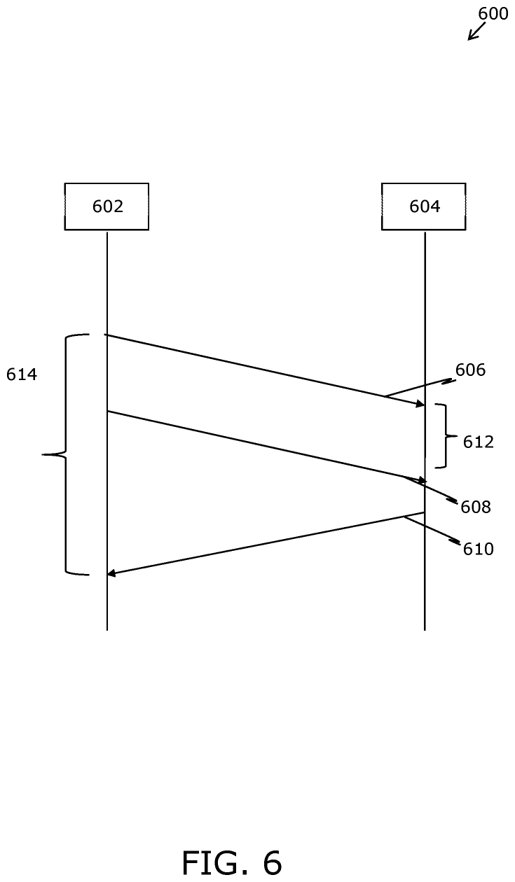

FIG. 6 is an illustration of an exemplary scenario of implementation of a remote direct memory access (RDMA) system with a prefetch hint, in accordance with an embodiment of the present disclosure. FIG. 6 is described in conjunction with elements from FIGS. 1, 2A, 2B, 3, 4, and 5. With reference to FIG. 6, there is shown an exemplary scenario of a RDMA system 600 that includes a requesting device 602 and a responding device 604. The requesting device 602 transmits a prefetch hint message 606 and a request 608 to the responding device 604. The responding device 604 transmits an acknowledgement message 610 as a response (or reply) to the request 608 to the requesting device 602. There is further shown a memory page-in latency 612 and a total transaction latency 614.

In the RDMA system 600, the requesting device 602 and the responding device 604 corresponds to the requesting device 102 and the responding device 104 of FIG. 1.

In operation, the requesting device 602 transmits the prefetch hint message 606 to the responding device 604 either in the form of a special data packet or as an additional payload (or a header) in existing data packets. The prefetch hint message 606 comprises a prefetch operation that includes prefetching of a memory address (e.g. a virtual address (VA 0X1000)) at the responding device 604. After receiving the prefetch hint message 606, the responding device 604 starts prefetching of the memory address (i.e. VA 0x1000) and loads the memory address (i.e. VA 0x1000) to a memory (e.g. the memory 210) of the responding device 604. At this point, the memory address (i.e. VA 0x1000) of the responding device 604 is ready to consider any request relating to data and to the memory address (i.e. VA 0X1000). The time taken by the responding device 604 from receiving the prefetch hint message 606 up to loading the memory address (i.e. VA 0X1000) to the memory 210 is termed as the memory page-in latency 612. Optionally, in a case, the responding device 604 may transmit a response message to the requesting device 602 which provides an information to the requesting device 602 about the successful execution of the prefetch hint message 606. In another case, the requesting device 602 may ask for the response message from the responding device 604 to know about the execution of the prefetch hint message 606. The communication of the response message for the prefetch hint message 606 may be implicit and happen dynamically, or configurable and negotiated between the requesting device 602 and the responding device 604. The requesting device 602 further transmits the request 608 (e.g. a write request as WRITE (VA 0x1000)) to the responding device 604. The responding device 604 receives the request 608 (i.e. the WRITE (VA 0x1000)) and writes the request data at the memory address (i.e. VA 0x1000). The responding device 604 transmits the acknowledgement message 610 to the requesting device 602 after executing the request 608 (i.e. the WRITE (VA 0x1000)). The requesting device 602 receives the acknowledgement message 610 which provides information about the successful execution of the request 608 at the responding device 604. After receiving the acknowledgement message 610, the requesting device 602 may start transmission of another request. The total time taken by the requesting device 602 from transmitting the prefetch hint message 606 to receiving the acknowledgement message 610 is termed as the total transaction latency 614. In the RDMA system 600, the total transaction latency 614 (or total completion time) is lower because the responding device 604 neither needs to drop the request 608 nor waits for retransmission in comparison to the conventional RDMA system where no prefetch hint message is used. The conventional RDMA system with limitations has been described in detail, for example, in FIGS. 1 and 2A.

In an exemplary aspect, the present disclosure provides a system (e.g. the RDMA system 100 or 600). The system (i.e. the RDMA system 100 or 600) comprises a requesting device (e.g. the requesting device 102 or 602) and a responding device (e.g. the responding device 104 or 604). In an implementation, the system (i.e. the RDMA system 100 or 600) may further comprises the requesting device 102 comprising the memory 202, the communication interface 206, and software modules 208 and the responding device 104 comprising the memory 210, the communication interface 214, and software modules 216. Various operations of the requesting device 102 and the responding device 104 and their components has been described in detail, for example, in FIGS. 1, 2A, and 2B, respectively.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the invention, which are, for brevity, described in the context of a single embodiment, may also be provided separately or in any suitable combination or as suitable in any other described embodiment of the disclosure.

1. A requesting device comprising:
a memory;
a controller; and
a communication interface, wherein the controller is configured to:
transmit a message comprising a prefetch operation to a responding device over the communications interface, the prefetch operation indicating a memory area to be loaded by the responding device to a memory of the responding device;
transmit a request to the responding device over the communications interface, the request relating to request data and to the memory area; and
receive a response message from the responding device over the communications interface.

2. The requesting device according to claim 1, wherein the request is a write command carrying the request data for writing the request data in the memory area, and wherein the response message is an acknowledgment for the write command.

3. The requesting device according to claim 1, wherein the request is a read command carrying a memory address for reading the request data from the memory address in the memory area and the response message is a message carrying read request data.

4. The requesting device according to claim 1, wherein the memory area is of a larger size than the request data and wherein the controller is further configured to transmit a plurality of requests relating to the memory area to the responding device over the communications interface.

5. The requesting device according to claim 1, wherein the controller is further configured to receive an acknowledgement message for the prefetch operation prior to transmitting the request.

6. The requesting device according to claim 1, wherein the controller is further configured to transmit the request after a wait time has lapsed from transmitting the prefetch operation.

7. The requesting device according to claim 1, wherein the message comprising the prefetch operation is a dedicated prefetch operation message.

8. The requesting device according to claim 1, wherein the message comprising the prefetch operation, comprises the prefetch operation in an additional payload of a request message of another request.

9. The requesting device according to claim 1, wherein the requesting device is arranged for Remote Direct Memory Access (RDMA).

10. A method for a requesting device, the requesting device comprising a memory, a controller and a communication interface, the method comprising:
transmitting a message comprising a prefetch operation to a responding device over the communications interface, the prefetch operation indicating a memory area to be loaded by the responding device to a memory of the responding device;
transmitting a request to the responding device over the communications interface, the request relating to request data and to the memory area; and
receiving a response message from the responding device over the communications interface.

11. The method according to claim 10, wherein the memory area is of a larger size than the request data and wherein the method further comprises transmitting a plurality of requests relating to the memory area to the responding device over the communications interface.

12. The method according to claim 10, further comprising receiving an acknowledgement message for the prefetch operation prior to transmitting the request.

13. The method according to claim 10, further comprising transmitting the request after a wait time has lapsed from transmitting the prefetch operation.

14. The method according to claim 10, wherein the message comprising the prefetch operation is a dedicated prefetch operation message.

15. A responding device, the responding device comprising a memory, a controller and a communication interface, the controller being configured to:
receive a message comprising a prefetch operation from a requesting device over the communications interface, the prefetch operation indicating a memory area to be loaded by the responding device to the memory;
load the memory area to the memory;
receive a request from the requesting device over the communications interface, the request relating to request data and to the memory area;
execute the request on the request data in the memory area; and
transmit a response message to the requesting device over the communications interface.

16. The responding device according to claim 15, wherein the controller is further configured to determine if the memory area is stored in the memory prior to loading the memory area to the memory, and in response to that the memory area is not stored in the memory, load the memory area to the memory.

17. The responding device according to claim 15, wherein the controller is further configured to transmit an acknowledgment message to the requesting device, wherein the acknowledgment message indicates whether the controller was able to load the memory area to the memory or not.

18. A method for a responding device, the responding device comprising a memory, a controller and a communication interface, the method comprising:
receiving a message comprising a prefetch operation from a requesting device over the communications interface, the prefetch operation indicating a memory area to be loaded by the responding device to the memory;
loading the indicated memory area to the memory;
receiving a request from the requesting device over the communications interface, the request relating to request data and to the memory area;
executing the request on the request data in the memory area; and
transmitting a response message to the requesting device over the communications interface.

19. The method according to claim 18, further comprising:
determining if the memory area is stored in the memory prior to loading the memory area to the memory; and
in response to that the memory area is not stored in the memory, load the memory area to the memory.

20. The method according to claim 18, further comprising transmitting an acknowledgment message to the requesting device, wherein the acknowledgment message indicates whether the controller was able to load the memory area to the memory or not.
